(19) United States
(12) Patent Application Publication
(10) Pub. No.: US 2018/0084229 A1
(43) Pub. Date: Mar. 22, 2018

(54) APPARATUS AND SYSTEM FOR ACCEPTING AND SECURING VIDEO MONITORS AND METHODS THEREOF

(71) Applicant: Nicole Cook, Geneva, IL (US)

(72) Inventor: Nicole Cook, Geneva, IL (US)

(21) Appl. No.: 15/670,629

(22) Filed: Aug. 7, 2017

Related U.S. Application Data
(60) Provisional application No. 62/371,316, filed on Aug. 5, 2016.

(51) Int. Cl. H04N 7/18; F16M 11/42; F16M 11/28; F16M 11/18; H04N 5/232; H04N 5/77

(52) U.S. Cl. CPC H04N 7/183; F16M 11/42; F16M 11/28; H02J 7/0042; H04N 5/23203; H04N 5/23296; H04N 5/77; F16M 11/18

(57) ABSTRACT

A monitor stand and system that can accept and secure a video monitor, camera, camcorder, phone camera or a similar recording device, which can be cordless and/or wireless, or can safely conceal any data cables or power cords from access, and being configured to manually or automatically position the recording device in multiple positions to capture or record the subject, further configured to allow for charging the secured recording device either by wire, contacts, or inductive charging, so that the stand portion of the monitor stand can be removed from the charging device portion and used without the need for external power, and configured with wheels and gears to move towards the charging base for charging the stand manually or automatically.

### BACKGROUND

### a. Technical Field

The instant disclosure relates to an apparatus and system for accepting and securing video monitors, cameras, camcorders, phone cameras and similar recording devices and the methods for accepting and securing those recording devices, and in particular, the instant disclosure relates to a baby monitor stand that can be cordless and/or wireless, or can safely conceal any data cables or power cords from access by the baby being recorded, and being configured for easy positioning of the recording device in multiple positions to capture or record the subject.

The instant disclosure is also configured as a system that includes the monitor stand apparatus, user device and web server to provide functionality for obtaining information, such as video and audio, temperature, humidity of a subject or subject location, providing video and audio transmissions to be displayed on the user device or to a third-party web server, for third-party watch or security services, along with manual or autonomous control over the monitor stand apparatus.

The instant disclosure is further configured to allow for charging the secured recording device either by wire, electrical contacts or inductive charging, so that the stand portion of the baby monitor stand can be removed from the charging device portion and used without the need for external power, and placed in one room or another.

The instant disclosure is also configured with wheels and motors, such as an electric motor, to allow the apparatus to move from location to location, either under remote control (using a smart phone for example) or autonomously for charging the apparatus or system either by wire, electrical contacts or inductive charging. In an example, the apparatus will determine if it needs to be charged and will move on its own using wheels, to the charging base, moving into electrical contact, accept a charge, and if necessary, move back to the original position. The system is further configured such that the user can remotely control the apparatus and system to move the device from one room to another for additional viewing or for charging.

Additionally, the instant disclosure uses motors and gears near the top of the monitor stand apparatus to direct and aim the recording device for optimal viewing and recording of video and images, along with control over the recording device, which may be integral with or separate to the monitor stand apparatus.

### b. Background of Disclosure

Camera stands and the like have been around for many years. The simplest camera stand is a tripod, which is made up of a platform for holding a camera and a portable three-legged frame used to support the weight of a camera. In use, the three legs of the tripod are positioned away from the vertical center, which allows for maintaining the stability of the tripod. Over time, tripods have been used in many different industries for holding and stabilizing measurement devices, such as photography, construction, surveying, etc.

Tripods or other camera stands have also been used in to support various monitoring or recording instruments, such as monitors, cameras, video recorders, camcorders, and telescopes, to name a few. In particular, tripods and other similar devices have been used to accept and support video monitors, such as those used to monitor a baby in another room. These baby monitor tripods or stands provide an easy way to view a sleeping baby, for instance, while attending to other matters in another room. However, current baby monitor stands have shortcomings that either prevent a simple positioning of the recording device for the best viewing of the subject or allow for the power cords or data cables to be inadvertently accessible to the baby, in which the baby could harm itself.

As an example, Dayan et al., Publication No. US2008/0309765, titled Portable Wireless Baby Monitor, discloses a method and system for monitoring, both audibly and visually, a child in any location. Dayan consists of a wireless camera that can conveniently be located both in a vehicle and in the home. The wireless camera transmits the image signal to a monitor that can be mounted within a vehicle or placed within the home. The monitor may be charged via a 12 V adapter, or by using a home base unit. The camera may have infrared sensors in order to see in dark conditions. Dayan discloses that, in the home, the device is mounted to the baby's crib, however, it could rest on a bookshelf, dresser, floor shelf and the like. As such, the placement of the Dayan device is contingent on the location of the furniture and may not be positioned in the optimal location to view the baby or the subject. Further, Dayan, once positioned, can be rotated on its base in either or both of two different axis, however, the camera stays in the vertical plane, which fails to allow for the optimal placement to view the baby. If mounted to the crib, the device may be accessible by the baby thereby creating a safety issue.

Another example is Babineau et al., Publication No. US2014/0192135, titled Child-Monitoring System, discloses a parent unit and a child unit, in which the child-monitoring system is configured to communicate audio and video signals between the parent unit and the child unit through a wireless connection so that the parent unit and the child unit may be maintained in a spaced-apart relation to one another. In an illustrative embodiment, Babineau discloses using two cameras, one with a wide-angled lens and one with a narrow-angled lens. The cameras are mounted on a foundation which is configured to be positioned on a dresser or desk. The placement of the Babineau device is contingent on the location of the dresser or desk and, as such, may not be positioned in the optimal location to view the baby or the subject. Again, Babineau discloses a device that does not allow for the optimal placement to view the baby.

Yet another example is the Baby Monitor—Night Vision, AV Out, Flower Design, Product Code: CVOW-1155-Blue, sold by Chinavision. The device incorporates a flower design and installs using a clip-on camera that can be placed on the baby's cradle or bed. The device has 8 IR lights that provide a bright night view of the baby. The placement of the device is disclosed as an attachment to the crib or bed, which does not provide optimal placement and may be reachable by the baby, thereby reducing the safety aspect of the device.

As such there is a need for a video monitor or baby monitor stand that improves upon known baby monitor stands, including those that attach to a crib or bed, those that contain power cords or data cables, and/or those that do not provide for optimal placement of the camera or video recording device.

Further, there is a need for a video monitor or baby stand that can be remotely controlled by the user or parent to move the device to a more advantageous location, either in the same room for a different viewing angle, or into a different room for different viewing altogether or for charging at a separate charging base.

The foregoing is intended only to illustrate the present technical field and background art and should not be taken as a limitation or disavowal of claim scope.

### BRIEF SUMMARY

The present disclosure is an improved monitor stand apparatus and system for accepting and securing video and recording devices and related methods for accepting and securing those recording devices for use in recording events, such as a baby in a crib, or the like. The monitor stand apparatus comprises a base section, a neck section and a device attachment section. The monitor stand apparatus also comprises a detachable charging base which couples to the base section for charging an internal battery or battery pack.

The present disclosure provides for a monitor stand apparatus that can be placed in a location (on the charging base or off) and rotated and/or tilted at its base section, extended, retracted, rotated, and/or tilted at its neck section, and rotated at the device attachment section, to obtain the optimal viewing angle. The monitor stand apparatus is also configured with a hollow neck section to conceal any wires, including power cords or data cables, thereby reducing or minimizing the chance of an accident from hanging or dangling wires.

The present disclosure is also an improved monitor stand apparatus and system for accepting and securing video and recording devices in which the monitor stand apparatus comprises an internal battery or battery pack, located inside the base section that can be charged by wire, by external electrical contacts or through inductive charging using the detachable or separate charging base. The internal battery or battery pack is connected to the device attachment section using power cords through the hollow neck section, so that the recording device attached to the monitor stand apparatus can be coupled or connected to the internal battery pack for power, whether the battery pack is being charged or not at the charging base.

The present disclosure further provides for a monitor stand apparatus that utilizes a ball joint connection to join the telescoping neck section to the device attachment section, so that the recording device, once attached to the device attachment section, can be rotated in conjunction with the ball joint to optimize the viewing angle of the recording device. Motors, such as electric motors and gears can be used to automate the rotation and aiming procedures of the recording device.

Further, the bottom of the base section is configured as round to allow for the base to be tilted at an angle when it is placed on the ground, again to optimize the viewing angle of the recording device. The monitor stand apparatus is bottom heavy to allow for tilting or slanting the stand in place without falling over. The charging base is also configured to accept the rounded base section bottom, so that the monitor stand apparatus can be tilted whether it is in the charging base or not. To the extent the charging base is located in another room, the monitor stand apparatus can be configured with wheels and gears both for retracting or telescoping the neck portion and for moving the monitor stand apparatus to or toward the charging base, either manually or automatically when the system determines that the apparatus and/or recording device needs charging.

The present disclosure also provides for a system that comprise the monitor stand apparatus described herein, a user device, such as a smart phone or computer, and a web server, one or more of which comprise a monitor control application, to provide functionality for obtaining information from the recording device attached to or integral with the monitor stand apparatus. The information obtained and/or transmitted through the system includes video and audio images, geographic location of the recording device, battery signal, night light function, temperature, and humidity of a subject or subject location, along with manual or autonomous control over the monitor stand apparatus. The video and audio images are transmitted to be displayed on the user device or to a third-party web server. The third-party to provide watch or security services, among other services based on the information captured and provided.

The present disclosure further provides for a monitor stand apparatus that utilizes a device attachment section comprising a ball joint connection to connect to the telescoping neck section. In this embodiment, the recording device, once attached to the device attachment section, can be rotated in conjunction with the ball joint to optimize the viewing angle of the recording device. Further, the bottom of the base section is configured as round to allow for the base to be tilted at an angle when it is placed on the ground, again to optimize the viewing angle of the recording device. Further, the charging base is configured to accept the rounded base section bottom, so that the monitor stand apparatus can be tilted whether it is in the charging base or not.

The present disclosure further provides for a monitor stand apparatus that utilizes a skirt or legs on the outside of the base section to prevent the base section from falling over when it is tilted. The skirt or legs can be used to prevent the tipping of the apparatus whether the monitor stand is sitting in the charging base or not.

As a non-limiting example, the instant disclosure relates to a baby monitor stand that can be positioned on the ground or on a charging base, and can be cordless or wireless, and will safely conceal any data cables or power cords from access by the baby or anyone else. The baby monitor stand can be placed, tilted, rotated and located in a position to obtain the optimal viewing angle to video or record the baby, based on in part, the heavier rounded bottom of the base section (in comparison to the neck section and the device attachment section), the telescoping and retractable shaft or neck, and the ball joint connection of the device attachment section.

As such, it is an objective of the present disclosure to be configured for charging the secured recording device either by wire, electrical contacts or inductively, so that the stand portion of the monitor stand apparatus can be placed on the charging device portion or charging base for charging an internal battery, and then removed from the charging base and used without the need for external power, or the charging base.

It is another objective of the present disclosure to be configured so the base can be tilted or rotated on the charging device and comprises a telescoping and retractable hollow neck for changing the height of the device and thus the height of the recording device. The hollow neck also contains any wires used in the system and keeps the wires from access by a baby or others and from getting accidentally tangled or inadvertently caught on furniture or other items.

It is also an objective of the present disclosure that the base can be removed from the charging device and placed on the floor, or on a table or in other rooms without the charging device and provide the same functionality as when it is placed on the charging device.

Additional objectives and advantages of the present disclosure will become apparent to one having ordinary skill in the art after reading the specification in light of the drawing figures, however, the spirit and scope of the present invention should not be limited to the description of the embodiments contained herein.

### BRIEF DESCRIPTION OF THE DRAWINGS

FIG. 1 is a perspective view of an exemplary embodiment of a baby monitor stand according to the present disclosure.

FIGS. 2A and 2B are perspective views of an exemplary embodiment of a charging device section of a baby monitor stand according to the present disclosure.

FIGS. 3A and 3B are perspective views of an exemplary embodiment of a base section of a baby monitor stand according to the present disclosure.

FIGS. 4A and 4B are perspective views of an exemplary embodiment of a neck section of a baby monitor stand according to the present disclosure.

FIG. 5 is a perspective view of an exemplary embodiment of a device attachment section of a baby monitor stand according to the present disclosure.

FIG. 6 is a perspective view of an exemplary embodiment of a cutaway device attachment section of FIG. 5 of a baby monitor stand according to the present disclosure.

FIG. 7 is a perspective view of an alternative exemplary embodiment of a baby monitor stand according to the present disclosure.

FIG. 8 is a perspective view of an exemplary embodiment of a baby monitor stand set in a bedroom according to the present disclosure.

FIG. 9 is a functional block diagram of an exemplary embodiment of a monitor stand apparatus and system according to the present disclosure.

### DETAILED DESCRIPTION

As stated herein, the objective of the present disclosure is to provide an improved apparatus and system for accepting and securing video and recording devices and related methods for accepting and securing those recording devices. The present disclosure provides for a device that can be placed in position and is configured to obtain the optimal viewing angle for an attached recording device, and is also configured to conceal any power wires or data cables to reduce the chance of accidents that occur from inadvertent hanging or dangling wires. As a non-limiting example, the instant disclosure relates to a baby monitor stand that can be positioned on the ground or in a charging base, and can be wired or wireless, and will safely conceal any data cables or power cords from access by the baby or anyone else. The baby monitor stand can be placed, tilted, rotated and located in a position to obtain the optimal viewing angle to video or record the baby. As such, in the foregoing discussion, and in particular, the description of the preferred embodiment herein, is intended only to illustrate and explain these objectives and should not be taken as a disavowal of claim scope.

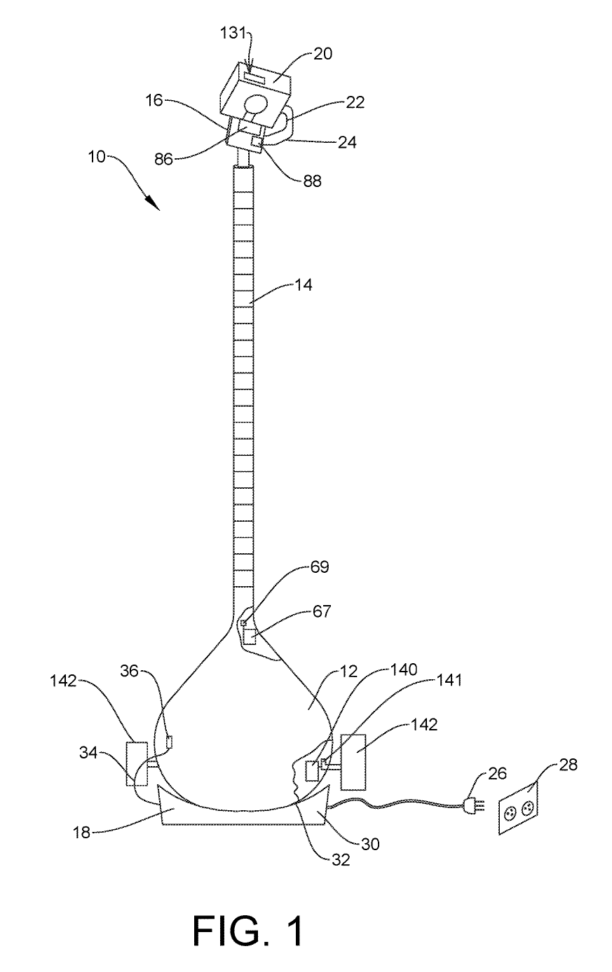

Referring to the drawings, wherein like reference numerals refer to the same or similar features in the various views, FIG. 1 is a perspective view of an exemplary embodiment of a baby monitor stand according to the present disclosure. In particular, FIG. 1 shows a monitor stand apparatus 10, which comprises a base section 12, a neck section 14 and a device attachment section 16. The monitor stand apparatus 10 also comprises a detachable charging base 18, which is configured in size and design to mechanically and electrically couple to the base section 12 for stability and charging purposes, as described herein. The detachable charging base 18 has a standard electrical plug 26, which can be plugged into a standard wall outlet 28 for electrical charging purposes. Additionally, the base section 12 can be attached to the charging base 18 so as to swivel when the base 12 is placed into the charging base 18, but not detach from the base 18. Of course, the monitor stand apparatus 10 can uncouple at other location on the apparatus 10 to protect from pinched fingers and the like.

Whether the base section 12 is placed in the charging base 18 or not, the monitor stand apparatus 10 that can be placed in a location and rotated and/or tilted at its base section 12, extended, retracted, rotated, and/or tilted at its neck section 14, and rotated at the device attachment section 16, to obtain the optimal viewing angle for a recording device 20 attached to the device attachment section 16. The monitor stand apparatus 10 is also configured with a hollow neck section 14 to conceal any wires, including power cords 22 or data cables 24, thereby reducing or minimizing the chance of an accident from hanging or dangling wires.

A typical recording device 20, as understood by one having ordinary skill in the art, would contain a video and still camera for recording video and still images, with controls for changing the zoom or aperture of the camera lens, and for changing various settings, such as ASA, depth of field, and other photographic settings. The recording device 20 can be integral with the monitor stand apparatus 10 or can be a separate piece of equipment that can be attached to and removed from the power 22 and data 24 cables or connections on the monitor stand apparatus 10 for separate use altogether. The recording device 20 may further contain a display, a microphone and a speaker or speakers for picking up sounds and allowing a user to talk to the subject being recorded, as described in detail herein, and as understood by one having ordinary skill in the art. Speakers 134, whether on the recording device 20 or separately integrated into the monitor stand apparatus 10, can be used to provide voice data, white noise or music, depending on the need.

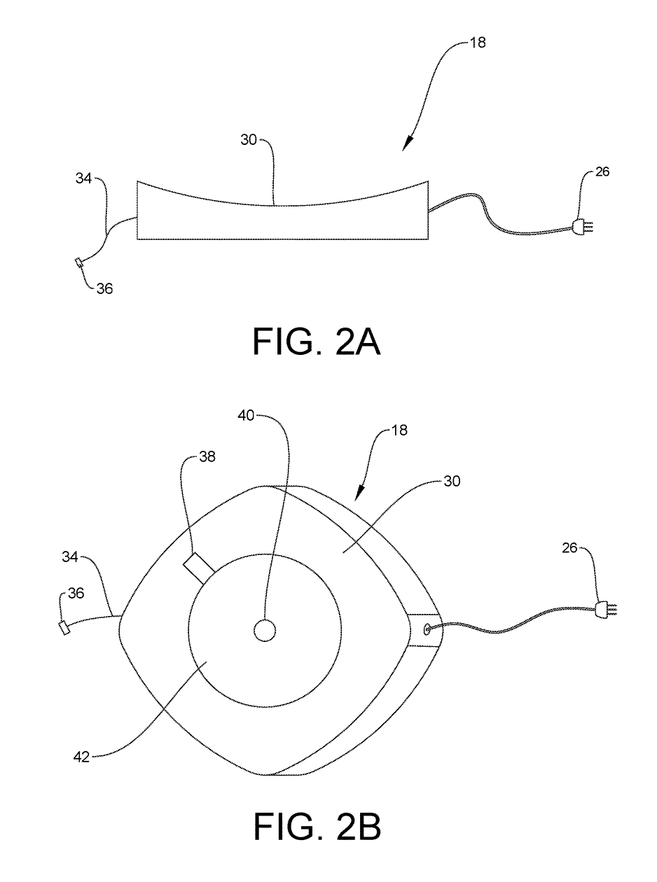

As shown in FIGS. 2A (side view) and 2B (top view), the top 30 of the charging base 18 is configured to accept the bottom 32 of the base section 12, so that the monitor stand apparatus 10 can be tilted when it is placed in the charging base 18, without falling over. However, the base section 12 is configured and shaped so that it can be tilted when it is not in the charging base 18, and still not fall over.

The charging base 18 comprises an electrical plug 26 for charging purposes and the charging base 18 can be used to charge the base section 12, or can be used to directly power the recording device 20 through power cord 22. There are a number of ways in which the charging base 18 can provide power to the base section 12. In one example, a charging base power cord 34 and associated electrical connector 36 can be used to connect power to the base section 12. In another example, charging electrical contacts 38, 40 on the top 30 of the charging base 18 can be used to provide power to the base section 12. In yet another example, an inductive charger or wireless charger utilizes a charging coil 42 that can be incorporated into the charging base 18, which utilizes an electromagnetic field to charge the base section 12. Other means for the charging base 18 to charge the base section 12 are contemplated.

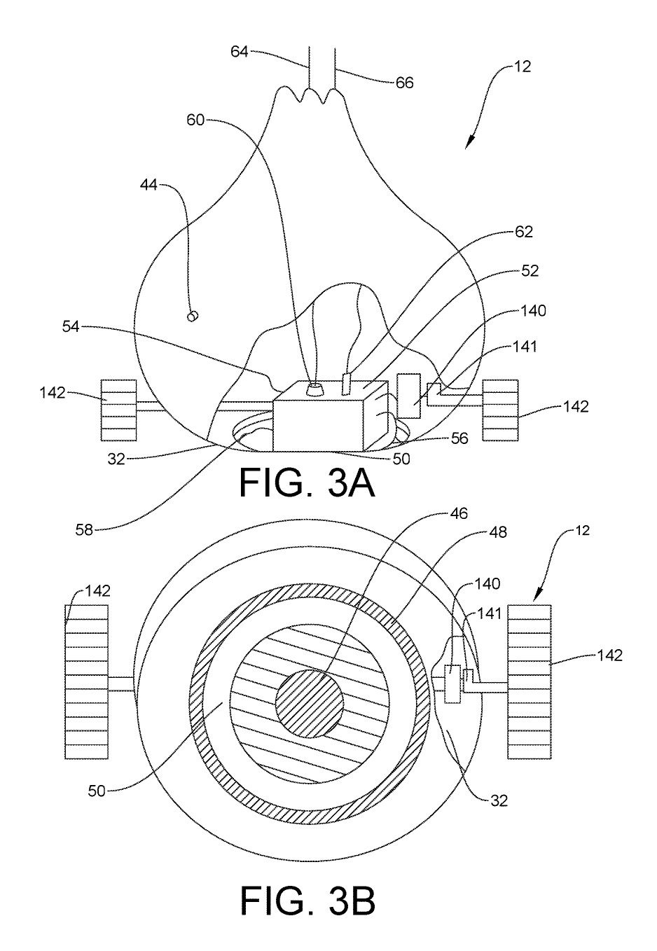

FIGS. 3A (side view) and 3B (bottom view) show the base section 12 of the present disclosure. In the preferred embodiment, the bottom 32 of the base section 12 is configured as partially round to allow for the base section 12 to be tilted at an angle when it is placed in the charging section 18 or on the ground, to optimize the viewing angle of the recording device 20. The base section 12 of the monitor stand apparatus 10 is bottom heavy, compared to the top of the monitor stand apparatus 10, to allow for tilting or slanting the monitor stand apparatus 10 in place without falling over. The bottom 32 of the base section 12 may be 5 to 10 times heavier (or more) than the device attachment section 16, as an example.

FIGS. 3A and 3B also show exemplary electrical contact arrangements for charging the base section 12 from the charging base 18. In the first example, the male electrical connector 36 (FIGS. 1 and 2) can be plugged into the female electrical counterpart 44. In another example, the bottom 32 of the base section 12 is configured for receiving electrical contacts 46, 48. These receiving electrical contacts 46, 48 are positioned and configured to match up with charging electrical contacts 40, 38 located on the top 30 of the charging base 18. With this arrangement, the base section 12 will be charged by the charging base 18, even if the base section 12 is tilted off its center axis in use. Yet another configuration that can be used to charge the base section 12 is inductive charging and the use of an inductive or wireless charger and a receiving coil 50, used in connection with the charging coil 42. Again, other charging systems are contemplated to charge the base section 12.

The base section 12 also comprises a charging system 52 (seen through the cutaway in FIG. 3A), which may include batteries and/or capacitors to store the charge or energy transmitted from the charging base 18. The charging system 52 can receive the charge from the charging base 18 in one of many ways. One example is through the electrical connector 36, through the female electrical connector 44, and a power cord 54 that is coupled to the charging system 52. Otherwise, through the receiving electrical contacts 46, 48, through power cords 56, 58. The charging system 52 can also be charged through inductive charging coupled to the receiving coil 50.

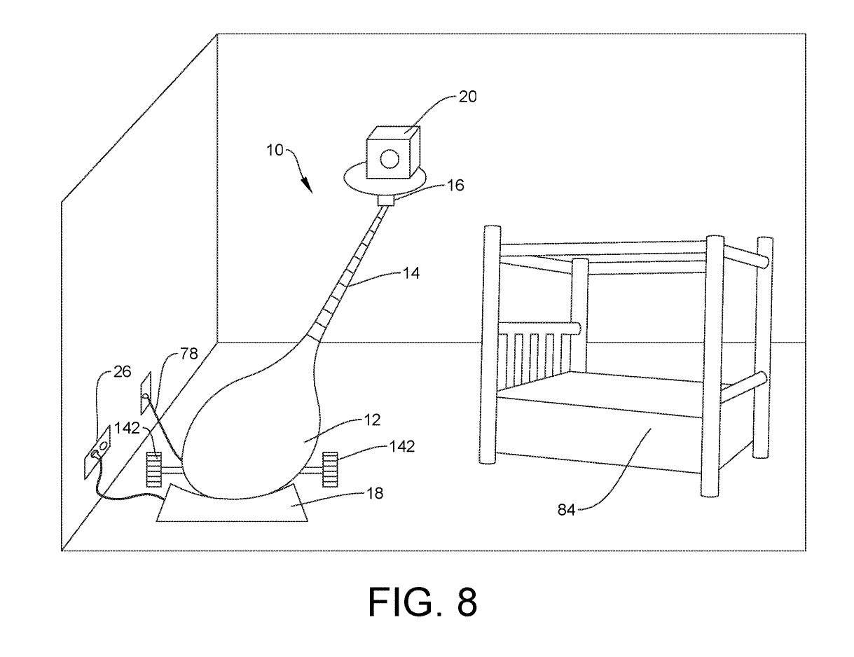

The charging system 52 can also be configured to wireles sly, transmit data to a monitor (not shown) so that the recording device 20 can wireles sly transmit video to the monitor. The transmission can use any one of numerous wireless protocols or can record the video for viewing at a later time. The video can also be transmitted through a wire 78 (see FIG. 8), such as Category 5 Networking Ethernet Cable, to an Ethernet port or connection, for transmission to a server or other receiving device.

Either way, or using a combination of these embodiments, the charging base 18 that is plugged into a standard wall outlet 28, provides a charge to the charging system 52 inside the base section 12, as long as the base section 12 is electrically coupled to the charging base 18, using one of the described methods. The charging system 52 further comprises an electrical connector 60 and a data connector 62. The electrical connector 60 can provide electrical power to the recording device 20 through a power cable 64, while the data connector 62, such as a USB connector, can provide a data connection to the recording device 20 through a data cable 66. As detailed herein, the power cord 64 and the data cable 66 travel to the recording device 20 through the neck section 14 of the Monitor Stand Apparatus 10. Once partially or fully charged, the charging system 52 can be used independent of the charging base 18 to continue to charge the recording device 20.

As described herein, the monitor stand apparatus 10 can be configured with a motor 140 (as shown in a cut away in FIG. 3A), such as an electric motor 140, connected to wheels 142 through gears 141, and connected to the charging system 52, for moving the monitor stand apparatus 10 from one location to the next in a room, moving the monitor stand apparatus 10 from room to room for recording and monitoring another subject, or to move the monitor stand apparatus 10 to a charging station for charging the device.

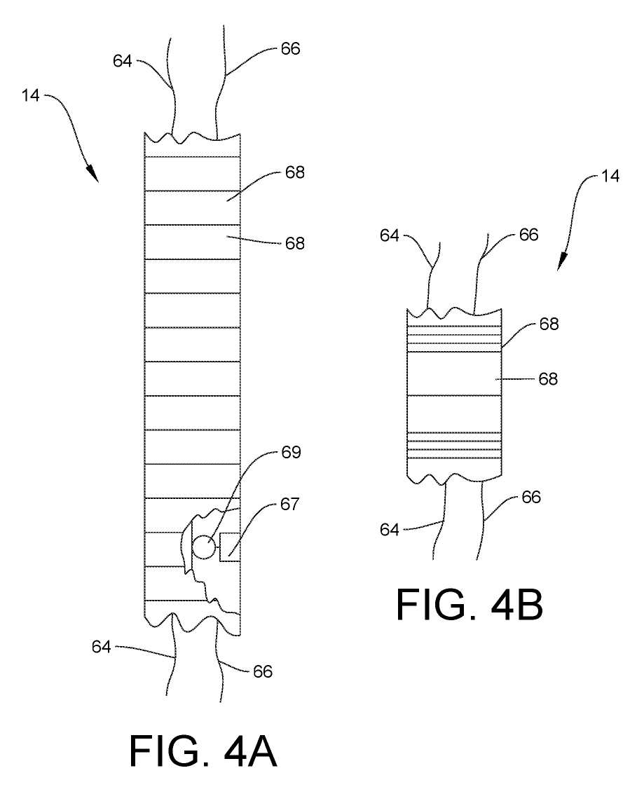

FIGS. 4A and 4B show the shaft or neck section 14 that connects the base section 12 to the device attachment section 16. In the preferred embodiment, the neck section 14 is made up of numerous segments 68 that are sized and configured to nest or slide into the adjacent segment 68. In doing so, the neck section 14 can be retracted or extended to increase or decrease the height of the overall monitor stand apparatus 10. The neck section 14 can also be configured to be rotated and/or tilted to create an optimal viewing. FIG. 4A shows the neck section 14 in the extended position, while FIG. 4B shows the neck section 14 in the retracted position. Whether the neck section 14 is in the extended position or the retracted position (or partially extended or retracted), the segments 68 are configured to lock in place, through a locking mechanism (not shown) or through tension of each segment 68 against the adjacent segment 68, so that the neck section 14 remains in the desired position. Further, the neck section 14 is hollow thereby allowing the power cord 64 and the data cable 66 to travel from the charging system 52 in the base section 12, to the device attachment section 16 and on the actual recording device 20. By hiding the cord 64 and cable 66 inside the hollow neck section 14, they will not be accessible, especially to a baby being monitored.

Additionally or alternatively, the neck section 14 may be configured with a motor 67 and gears 69 (cut away FIG. 4A) for controlling the extension or retraction of the neck section or portion 14. In this configuration, the user can retract or extend the recording device stand 70 of the monitor stand apparatus 10 and thus the recording device 20 lower or higher depending on need. Further, the neck portion 14 motor 67 and gears 69 can be configured to automatically retract the neck portion 14, and to lower the recording device 20, prior to moving the monitor stand apparatus to or towards the charging base for charging via electrical contact or inductive charging. The system 100 can determine when such charge is necessary and retract the neck portion 14 and move the monitor stand apparatus 10 to the charging base 18 automatically.

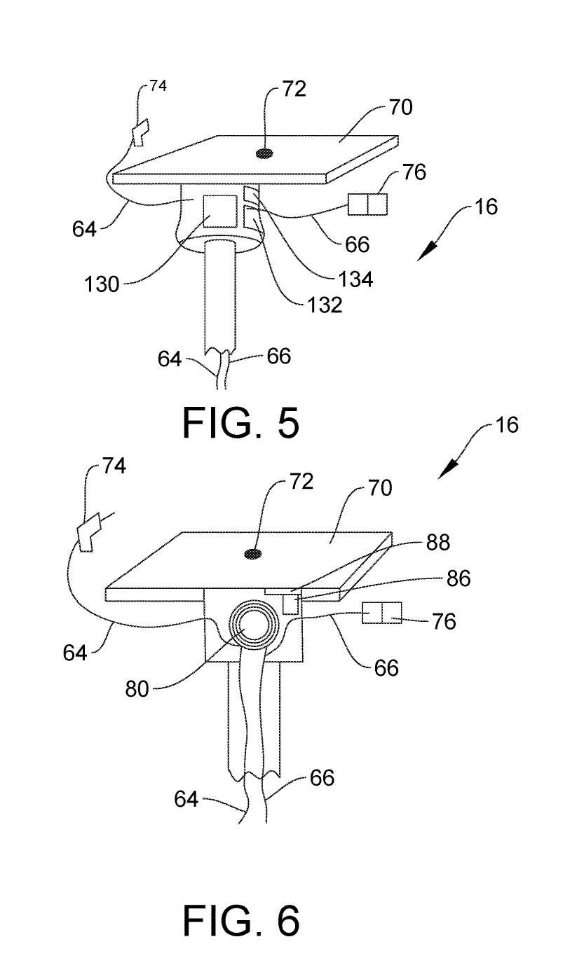

FIGS. 5 and 6 (cutaway) show the device attachment section 16 which is near the top of the monitor stand apparatus 10 and is configured to accept and support a recording device 20. The device attachment section 16 comprises a recording device stand 70 with a device attachment 72 to hold the recording device 20 to the recording device stand 70. The recording device 20 can further be electrically connected to the monitor stand apparatus 10 using the device power connector 74, which is electrically connected to the power cord 64. The recording device 20 is also connected to the monitor stand apparatus 10 using the device cable connector 76, which may be a mini-USB connector, among others, and is connected to the data cable 66. The recording device stand 70 can be configured with a display 130, which can be used in conjunction with or instead of a similar display 131 on the recording device 20, to indicate power levels of the charging system 52 (FIG. 3A) or the recording device 20, to aim the recording device 20 at the particular subject, as a night light, etc. Additionally, the recording device stand 70 can be configured with a microphone 132 and/or a speaker 134, as described herein, for providing audio from the user (through the user device 114), for providing music, pink or white noise to the subject of the recording device 20, etc. The microphone 132 and speaker 134 can also be used instead of or in conjunction with similar devices providing similar functionality on the recording device 20.

In use, the recording device 20 is mechanically attached to the recording device stand 70 and connected to power using the device power connector 74, and to data, using the device cable connector 76. Now the recording device 20 will receive power from the charging system 52 and be able to send data through the charging system 52 whether the base section 12 is coupled to the charging base 18 or not.

Of course, the recording device 20 can also be connected through Wi-Fi, Bluetooth, Zigby or any other wireless protocol, without the need for the device cable connector 76 and the associated wiring. Further, the recording device 20 may be running on its own battery power, thereby obviating the need for the device power connector 74 and the associated power hardware.

FIG. 6 shows a cutaway of the device attachment section 16 in FIG. 5. In the preferred embodiment, the device attachment section 16 comprises a ball joint connection 80 to join the telescoping neck section 14 to the device attachment section 16. In doing so, the recording device 20, once attached to the recording device stand 70, can be rotated in conjunction with the ball joint 80 to optimize the viewing angle of the recording device 20. A motor 86 and gears 88 can be incorporated into the recording device stand 70 to control the movement of the recording device stand 70 and thus the attached recording device 20. As understood, the recording device 20 can be separate from the monitor stand apparatus 10 or integral with the stand apparatus 10.

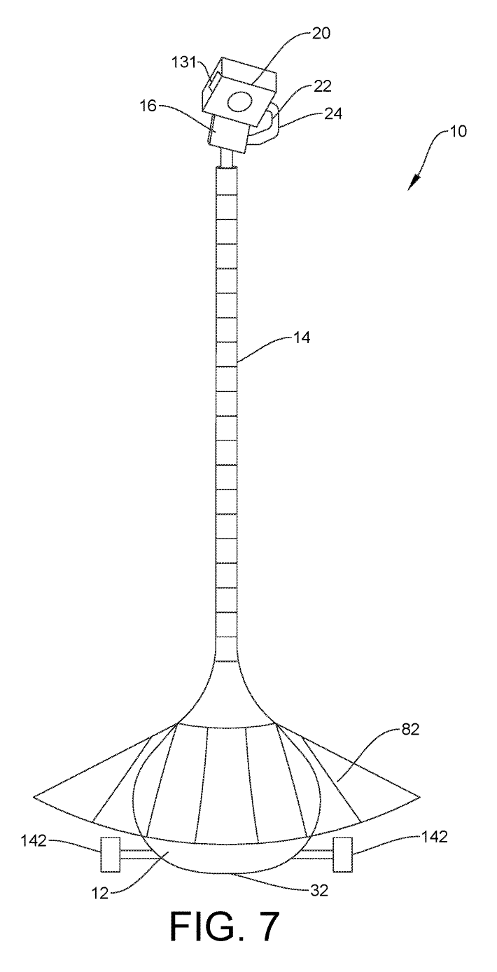

FIG. 7 shows an alternative embodiment in which the monitor stand apparatus 10 further comprises a skirt 82 on the outside of the base section 12 to prevent the base section 12 from falling over when it is tilted. The skirt 82 can be used to prevent the tipping of the apparatus whether the monitor stand apparatus 10 is sitting in the charging base 18 or not. Additionally, the monitor stand apparatus 10 can comprise legs (not shown) to function similar to the skirt 82 to prevent the monitor stand apparatus from tipping.

FIG. 8 shows the monitor stand apparatus 10 in use in a baby's bedroom with a crib 84 where the baby sleeps. In the room, the monitor stand apparatus 10 is tilted at the base section 12 while sitting in the charging base 18. The recording device 20 is securely attached to the device attachment section 16 and the neck section 14 is in the extended state to provide the optimal viewing angle of the baby in the crib 84. The charging base 18 is plugged into the electrical receptacle by the plug 26 and the base section 12 is connected to the Internet using the Ethernet cable 78. As such, the recording device is powered by charging system 52 and transmits video to a monitor (not shown) somewhere else in the house or elsewhere.

Additionally, the video monitor system 100, also referred to herein as system, can be configured to allow the user remote access and control of the monitor stand apparatus 10, including remote control from a computer, cell phone or dedicated remote, among others, as long as those devices have access to the Internet through a Wi-Fi connection, or access to a cellular network, or some similar communication protocol. As described below, the monitor stand apparatus 10 is configured to access a global communication network, such as the Internet through Wi-Fi, or access a cellular network, or access some similar communication bus and/or other wired or wireless electronic communication means, and will thus be able to communicate over a communication network to the remote device, as understood by one having ordinary skill in the art.

In this configuration, as detailed below, the user can access video and audio from the recording device 20 attached to the monitor stand apparatus 10, and control of the monitor stand apparatus 10 itself. The video and audio signals, which has been described herein, includes video and audio of the subject of the recording device 20 but, based on the communication protocol, also includes the ability to control sound, music or even the user's voice coming from speakers on the recording device 20 or on the monitor stand apparatus 10 itself, along with the ability to control the video display 131 on the recording device 20 or on the monitor stand apparatus 10 itself. Further, besides having access to the recording device 20, the user has access to the monitor stand apparatus 10 itself, including movement of the wheels 142 (and the device 10 itself), the movement (or aim) of the recording device 20, and the configuration of the device (extending or contracting of the telescoping neck section 14), for moving purposes, for example, to move to another room to be charged.

As described herein, the monitor stand apparatus 10 is configured to determine when the charge on the system 10 is low and the device will seek out the charging station, even if it is located in another room, for recharging. In doing so, the monitor stand apparatus 10 may reduce its size by contracting the neck section 14 and then roll to the charging station 18 for recharging, either through a direct electrical connection or through inductive charging.

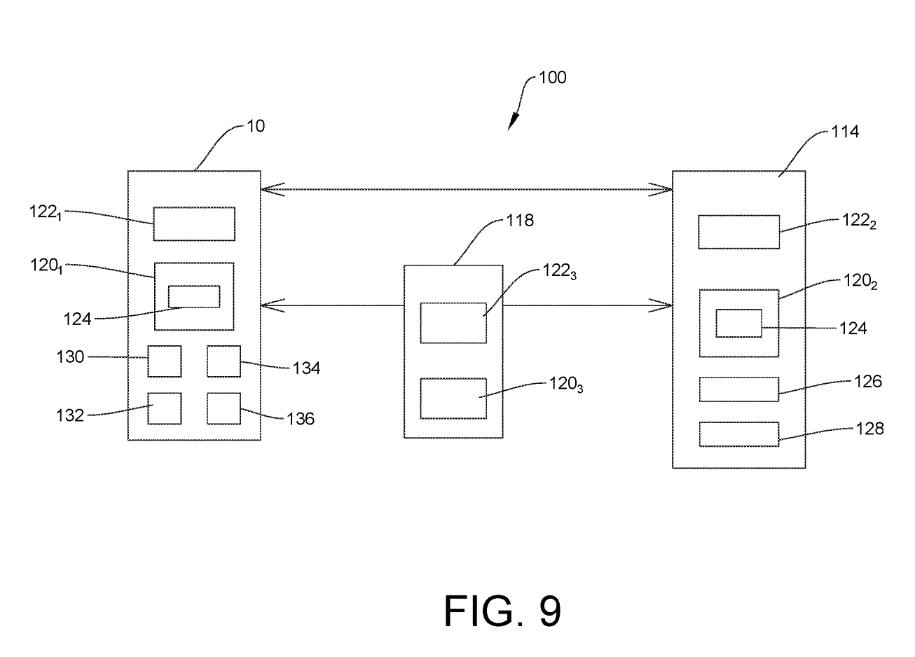

Accordingly, FIG. 9 is a block diagram view of an exemplary video monitor system 100, including, but not limited to, baby monitor systems. The system 100 may include a monitor stand apparatus 10 (as described above); a user device 114, such as a smart phone, a computer or a dedicated device; a monitor database 116; and a web server 118. The monitor database 116 may be located in one or more of the monitor stand apparatus 10, user device 114 or web server 118, however, it is shown as a separate entity in FIG. 9.

The monitor stand apparatus 10, the user device 114, and the web server 118 may each include a respective computer-readable memory 120₁, 120₂, 120₃ (which may be referred to generically as a memory 120) configured to store instructions, and a respective processor 122₁, 122₂, 122₃ (which may be referred to generically as a processor 122) configured to execute the instructions stored in the associated memory 120₁, 120₂, 120₃. A first copy or version of a monitor control application 124 (which may be referred to herein simply as “the application 124”) may be stored in the memory 120₁ associated with the monitor stand apparatus 10, and a second copy or version of the monitor control application 124 may be stored in the memory 120₂ associated with the user device 114. Finally, a third copy or version of the monitor control application 124 may be stored in the memory 120₃ associated with the web server 118. The user device 114 may additionally include input/output devices 126, such as a touch screen display, microphone, and speakers, along with a web browser 128. As described herein, the monitor stand apparatus 10 may additionally include one or more of a display 130, a microphone 132, a speaker 134 and a web browser 136.

Information, data, programs, etc. that is installed, stored, loaded or located in a computer-readable memory may be in any form. For example, the application 124 may be stored in a memory 120 in executable form, in the form of an installation file, in a non-executable form comprising the files and directories necessary to build an executable version of the application 124, or in some other form. Further, the memory may be accessible for storing data, etc. over the communication protocols described herein, along with any other devices configured for the transfer of such data, such as USB connectors, SD or micro SD card readers, and the like. These devices and methods allow for the user to update application programs, store video and audio data and upload and download such data as necessary. As a non-limiting example, an exemplary video monitor system 100 may record video of a sleeping baby over a one-hour period and the user may be able to transfer that video to a SD card for access remotely from the system 100.

Each processor 122 and memory 120 may be of a suitable type and in a suitable configuration for the functionality described herein. Additionally or alternatively, any of the user device 114, monitor stand apparatus 10, and web server 118 may include a programmable logic device (PLD), application-specific integrated circuit (ASIC), or other processing device. Each memory 120 may be or may include any non-volatile computer-readable memory, in an embodiment. Each associated processor 122 and memory 120 may be in communication with another processor 122 and memory 120 via any communication bus and/or other wired or wireless electronic communication means. In addition, the display 126 of the user's device 114 may be in communication with the processor 122 and/or memory 120 of the user device 114 over any communication bus and/or other wired or wireless electronic communication means.

The user device 114 may be or may include a personal computer or mobile device (e.g., tablet, smart phone), in an embodiment. However, the user device 114 is not limited to such embodiments. Rather, the user device 114 may be any computing system appropriate for performing the functionality described herein, including, but not limited to, using the display 126 to monitor the video being recorded on the recording device 20, listening to audio, speaking over the speakers, controlling the position of the recording device 20 by moving motors 86 (and gears 88) located on the monitor stand apparatus 10, or moving the monitor stand apparatus for additional recording or charging.

In an embodiment, the user device 114 may include the web browser 128 (e.g., a web browser 128 may be installed in the memory 120₂ of the user device 114). The user device 114 may be in electronic communication with the web server 118 (e.g., over the Internet). The web server 118 may provide one or more web pages that may be accessed by the user device 114 (e.g., via the web browser 128) and viewed on the display 126. Such web pages may include viewing and audio options and controls, or pages associated with one or more of the functionalities described herein.

The monitor database 116 may be or may include one or more data repositories including, but not limited to, one or more databases and database types as well as data storage that may not necessarily be colloquially referred to as a “database.” As described herein, the monitor database 116 may store records of one or more video or audio recordings from the recording device 20 along with other information about the monitor stand apparatus 10, such as light levels, temperature, humidity and other metrics and telemetry in the location of the monitor stand apparatus 10. The monitor database 116 may be accessed by the system 100, the user using the user device 114 or the web server 118, depending on the need for accessing the data by the user, the need to access the data by the system 100, or the need to update the monitor control application 124. The monitor database 116 may additionally or alternatively be maintained by a third party or by a user of the user device 114.

In an embodiment, the monitor database 116 may include a single database of information pertaining to the functionalities of the system 100 as described herein. Such a monitor database 116 may be maintained by an operator of the system 100, a user of the system (through the user device 114), a user of the system 100 (through the monitor stand apparatus 10), a user (through the web server 118), or by a third party. Accordingly, in an embodiment, a single monitor database 116 may be provided in the system 100, located in either one or more of the user device 114, the monitor stand apparatus 10, the web server 118, or even at a third-party location, for example.

As used in this disclosure, a “user” may refer to an individual or a larger entity. For example, a user may be an individual using the video monitor system 100 to record and monitor a sleeping child, or an entity such as a business that provides “watch” services for home security, to watch children, etc. In the latter situation, the monitor stand apparatus 10 may communicate directly to the web server 118, controlled by the entity, such that in the case of an illegal home invasion, the entity may have authority to contact a first responder, such as the police or fire department.

As described herein, the user may access the monitor database 116 through the user device 114, which can provide secure access to the database 116, in an embodiment. Thus, an entity may access multiple databases 116 of numerous individual users through each individual user's monitor stand apparatus 10. In this situation, the database may be accessed by each individual user via credentials provided by a third party that maintains the database, such that each individual user can only access that user's account and information. Alternatively, an entity may access multiple databases 116 of numerous individual users through each individual user's multiple monitor stand apparatuses 10.

The monitor control application 124, which is generally located in the memory 20₁ of the monitor stand apparatus 10, and in the memory 20₂ of the user device 114, may be generally configured, in an embodiment, for performing various functionality as described herein. In general, the functionality of the system 100 includes, but is not limited to, monitoring and recording video of a subject using the recording device 20 on the monitor stand apparatus 10 and the display 126 on the user device 114 (or the web server 118), and storing the data in the database 116. Additionally, the functionality of the system 100 includes, but is not limited to, listening to audio of a subject using a microphone 132, either on the recording device 20 or the monitor stand 70 of the monitor stand apparatus 10 (or both), and providing audio from a user to the subject through the user device 114 and speakers 134 on the recording device 20 or located on the monitor stand apparatus 10. Additional speaker 134 functionality includes playing white or pink noise or music over the speakers 134 on the recording device 20 or located on the monitor stand 70 of the monitor stand apparatus 10.

Additionally, the system 100 and, in particular, the monitor stand apparatus (possibly through the monitor control application 124) can be configured with a sleep mode whereby the system 100, the monitor stand apparatus 10 or the recording device 20 will enter a sleep mode when there is no noise or movement by the subject. This sleep mode will preserve battery power for the monitor stand apparatus 10, the recording device 20, or both. Once the subject being recorded moves or makes a sound, the system 100, monitor stand apparatus 10 or recording device 20 (and possibly, all three) will “wake up” to continue recording and monitoring. The system 100 is configured to send out email, text or any other similar notifications over the user device 114, for example, based on the movement or sound of the subject, including sending such communications if the videos or sounds are noticeably different than previous videos or sounds.

The video monitor system 100, through the user device 114 or the web server 118, also can control the direction and aim of the recording device 20 located on the monitor stand apparatus 10. The monitor stand apparatus 10 is configured with a motor at the top of the monitor stand apparatus 10 near the recording device stand 70, such as an electric motor, and connected to the ball joint connection 80 to allow for manual and automatic rotation of the recording device stand 70 for optimization of the viewing angle of the recording device 20. This control can be utilized separately or in conjunction with the control of the recording device 20 to better optimize the video and images to be recorded.

The video monitor system 100 is further configured to control the monitor stand apparatus 10 for additional functionality. The video monitor system 100, through the user device 114 or the web server 118, can control the location of the monitor stand apparatus 10, either manually or automatically. The monitor stand apparatus 10 is configured with a motor 140, such as an electric motor, connected to wheels 142 (cut away FIG. 3A) through gears 141, for moving the monitor stand apparatus 10 from one location to the next in a room, from room to room for recording and monitoring another subject, or to move the monitor stand apparatus 10 to a charging station for charging the device. In doing so, the neck portion 14 on the monitor stand apparatus 10 may be retracted to reduce the size and center of gravity of the monitor stand apparatus 10. Additional motors and gears in the monitor stand apparatus 10 can be used to extend and retract the neck portion 14 of the monitor stand apparatus 10.

As described above, information that can be identified and collected by the monitor control application 124 and transmitted to the database 116 may include, but is not limited to, video and audio of the subject being recorded, time and geographic location, temperature, humidity, among other information. The monitor control application may compare collected information with information stored in the monitor database 116 to determine if the current viewed and measured information is similar or noticeably different than similar information recorded previously.

In an embodiment, the monitor control application 124 may be associated with the web browser 128 on the user device 114. For example, the monitor control application 124 may be an extension, plug-in, or add-on to the browser 28. As noted above, the monitor control application 124 may be configured to obtain information, including information from the browser interface and to transmit that information on the browser interface for display on the display 126 of the user device 114.

As noted above, a third party may maintain the monitor database 116. In an embodiment, the monitor database 116 may be maintained by a provider of the monitor control application 124. Thus, a third party may retrieve the information from the monitor stand apparatus 10 described above, and store that information in the database 116. The retrieval may be performed by the application 124, in an embodiment. Further, the same third party may use that information to make decisions as to the safety of the subject of the recording device 20 or of the residence at the geographic location. The third party may also provide the application 124 by, for example, offering the application 124 on a software-as-as-service basis, offering the application 124 for download by the user, or on some other basis.

Reference throughout the specification to “various embodiments,” “some embodiments,” “one embodiment,” or “an embodiment,”, or the like, means that a particular feature, structure, or characteristic described in connection with the embodiment is included in at least one embodiment. Thus, appearances of the phrases “in various embodiments,” “in some embodiments,” “in one embodiment,” or “in an embodiment”, or the like, in places throughout the specification are not necessarily all referring to the same embodiment.

Further, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional. Although numerous embodiments of this invention have been described above with a certain degree of particularity, those skilled in the art could make numerous alterations to the disclosed embodiments without departing from the spirit or scope of this disclosure.

All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the any aspect of the disclosure.

As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

1. A video monitor system, comprising:
a monitor stand apparatus, said monitor stand apparatus comprising a recording device, a charging base, a base section, a neck portion, a recording device stand, wheels, a first motor and a first set of gears, wherein said wheels are connected at said base section to said first motor using said first set of gears;
a user device; said user device comprising a monitor control application and a display; and
a web server, said web server comprising a monitor control application;
wherein said recording device is located on said recording device stand to obtain video of a subject, and said video is transmitted through said web server to the user device for display on the display device of said user device to said user.

2. The video monitor system of claim 1 wherein said first motor is actuated to move the wheels of said base section and to move said monitor stand apparatus to said charging base for charging of said monitor stand apparatus.

3. The video monitor system of claim 2 wherein said user controls said first motor through said monitor control application by controlling said motor to move said base section of said monitor stand apparatus to said charging base for charging of said monitor stand apparatus.

4. The video monitor system of claim 2 wherein said first motor is actuated automatically through said monitor control application when said monitor stand apparatus needs to be charged by controlling said motor to move said base section of said monitor stand apparatus to said charging base for charging of said monitor stand apparatus.

5. The video monitor system of claim 1 wherein said recording device is integrated with said monitor stand apparatus.

6. The video monitor system of claim 1 wherein said recording device is separated from said monitor stand apparatus.

7. The video monitor system of claim 1 wherein said neck portion is telescoping.

8. The video monitor system of claim 1 wherein said neck portion further comprises a second motor and a second set of gears for extending and retracting said telescoping neck portion.

9. The video monitor system of claim 1 wherein said recording device stand further comprises a third motor and third set of gears, said third motor and third set of gears controlled by said user from said user device for directing and aiming said recording device stand for optimal viewing of said recording device.

10. The video monitor system of claim 1 wherein said user device comprises one of a smart phone or computer.

11. A monitor stand apparatus, comprising:
a recording device stand, said recording device stand configured to accept and secure a recording device;
a base section;
a charging system;
a charging base, said charging base configured to accept said base section for charging said charging system of said monitor stand apparatus;
a neck portion;
a first motor;
a first set of gears, and
a set of wheels, said wheels connected at said base section to said first motor using said first set of gears;
wherein said first motor is actuated to move the wheels of said base section and to move said monitor stand apparatus to said charging base for charging of said monitor stand apparatus.

12. The monitor stand apparatus of claim 11 wherein said user controls said first motor through said monitor control application by controlling said motor to move said base section of said monitor stand apparatus to said charging base for charging of said monitor stand apparatus.

13. The monitor stand apparatus of claim 11 wherein said first motor is actuated automatically through said monitor control application when said monitor stand apparatus needs to be charged by controlling said motor to move said base section of said monitor stand apparatus to said charging base for charging of said monitor stand apparatus.

14. The monitor stand apparatus of claim 11 further comprising a recording device accepted and secured to said recording device stand.

15. The monitor stand apparatus of claim 14, wherein said recording device is integrated with said monitor stand apparatus.

16. The monitor stand apparatus of claim 14 wherein said recording device is separated from said monitor stand apparatus.

17. The monitor stand apparatus of claim 1 wherein said neck portion is telescoping.

18. The monitor stand apparatus of claim 1 wherein said neck portion further comprises a second motor and a second set of gears for extending and retracting said telescoping neck portion.

19. The monitor stand apparatus of claim 14 wherein said recording device stand further comprises a third motor and third set of gears, said third motor and third set of gears controlled by a user through a user device for directing and aiming said recording device stand for optimal viewing of said recording device.

20. The monitor stand apparatus of claim 19 wherein said user device comprises one of a smart phone or computer.
